(19) United States
(12) Patent Application Publication
(10) Pub. No.: US 2026/0343699 A1
(43) Pub. Date: Oct. 29, 2026

(54) DRIVE CONTROL CIRCUIT, DRIVE SYSTEM AND DISPLAY APPARATUS

(71) Applicants: Beijing BOE Technology Development Co., Ltd., Beijing (CN); BOE Technology Group Co., Ltd., Beijing (CN)

(72) Inventors: Nan HAN, Beijing (CN); Zijiao XUE, Beijing (CN); Wenhong TIAN, Beijing (CN); Fei LIANG, Beijing (CN); Zhiqiang WANG, Beijing (CN); Xin MA, Beijing (CN)

(21) Appl. No.: 18/997,290

(22) PCT Filed: Nov. 24, 2023
(86) PCT No.: PCT/CN2023/134010

§ 371 Date: Jan. 21, 2025

(51) Int. Cl. H05B 45/30

(52) U.S. Cl. CPC H05B 45/30

(57) ABSTRACT

A drive control circuit, a drive system and a display apparatus. The drive control circuit includes: a voltage conversion sub-circuit, a first shunt sub-circuit, a conduction control sub-circuit, and a second shunt sub-circuit. The voltage conversion sub-circuit outputs a supply voltage to a supply terminal; the first shunt sub-circuit generates a first voltage at a current-limiting node based on the supply voltage at the supply terminal; the conduction control sub-circuit generates a control voltage at a control node and generates a current flowing through the supply terminal to the ground terminal in response to the first voltage at the current-limiting node and the supply voltage at the supply terminal; and the second shunt sub-circuit establishes a conducting path between the current-limiting node and the ground terminal in response to a voltage at the control node being greater than a first conduction threshold.

### CROSS-REFERENCE TO RELATED APPLICATIONS

The disclosure is a National Stage of International Application No. PCT/CN2023/134010, filed on Nov. 24, 2023, which is hereby incorporated by reference in its entirety.

### TECHNICAL FIELD

The present application relates to the field of display technology, and provides a drive control circuit, a drive system and a display apparatus.

### BACKGROUND

At present, in a process that the Mini light-emitting diode (LED) related display apparatus is powered on, there may be a situation in which a high current is triggered by mistake or a situation in which the power filter capacitor inside the chip and other devices inside the chip generate parasitic oscillations on the power, etc. Both of the above situations may result in the generation of a high current, such as a surge. Generally, the capacitor inside the chip for controlling the Mini LED-related display apparatus can absorb a high current of up to 120 mA. When the above high current is higher, the load resistor inside the chip for processing the logic function may be damaged, and in serious cases, the Mini LED-related display apparatus may display poorly.

### SUMMARY

Embodiments of the present application provide a drive control circuit, a drive system and a display apparatus, to limit the magnitude of a current at a supply terminal, thereby effectively reducing the current flowing through the supply terminal, and improving the reliability of the supply voltage.

The specific technical solutions provided in the application are as follows.

In a first aspect, an embodiment of the present application provides a drive control circuit, including: a voltage conversion sub-circuit, a first shunt sub-circuit, a conduction control sub-circuit, and a second shunt sub-circuit. The voltage conversion sub-circuit is configured to output a supply voltage to a supply terminal; the first shunt sub-circuit is coupled to the supply terminal and a current-limiting node, and is configured to generate a first voltage at the current-limiting node based on the supply voltage at the supply terminal; the conduction control sub-circuit is coupled to the supply terminal, the current-limiting node and a ground terminal, and is configured to generate a control voltage at a control node and generate a current flowing through the supply terminal to the ground terminal in response to the first voltage at the current-limiting node and the supply voltage at the supply terminal; and the second shunt sub-circuit is coupled to the control node, the current-limiting node, and the ground terminal, and is configured to establish a conducting path between the current-limiting node and the ground terminal in response to the control voltage at the control node being greater than a first conduction threshold, for shunting the current generated by the conduction control sub-circuit.

Optionally, the first shunt sub-circuit includes: a first resistor; and a first end of the first resistor is coupled to the supply terminal, and a second end of the first resistor is coupled to the current-limiting node.

Optionally, the conduction control sub-circuit includes: a load resistor, a first transistor, and a current-limiting resistor; a first end of the load resistor is coupled to the supply terminal, and a second end of the load resistor is coupled to a first end of the first transistor; a control end of the first transistor is coupled to the current-limiting node, and a second end of the first transistor is coupled to the control node; and a first end of the current-limiting resistor is coupled to the control node, and a second end of the current-limiting resistor is coupled to the ground terminal.

Optionally, a resistance value of the first resistor is less than a resistance value of the load resistor, and the resistance value of the first resistor is less than a resistance value of the current-limiting resistor.

Optionally, the second shunt sub-circuit includes: a shunt control unit and a second resistor; the shunt control unit is configured to establish a conducting path between the current-limiting node and the second resistor in response to a current value at the control node being greater than the first conduction threshold, for shunting the current generated by the conduction control sub-circuit; and the second resistor is configured to conduct a shunt current, obtained by shunting the current generated by the conduction control sub-circuit, to ground.

Optionally, the shunt control unit includes a first Metal-Oxide-Semiconductor (MOS) tube; and a control end of the first MOS tube is coupled to the control node, a first end of the first MOS tube is coupled to the current-limiting node, and a second end of the first MOS tube is coupled to a first end of the second resistor.

Optionally, the shunt control unit includes: a first shunt control sub-unit and a second shunt control sub-unit; the first shunt control sub-unit is configured to establish a conducting path between the current-limiting node and the second resistor in response to a voltage of an alternating current component at the control node being greater than the first conduction threshold, for shunting the current generated by the conduction control sub-circuit; and the second shunt control sub-unit is configured to establish a conducting path between the current-limiting node and the second resistor in response to a voltage of a direct current component at the control node being greater than the first conduction threshold, for shunting the current generated by the conduction control sub-circuit.

Optionally, the first shunt control sub-unit includes: a capacitor and a second MOS tube; a first end of the capacitor is coupled to the control node, and a second end of the capacitor is coupled to a control end of the second MOS tube; and a first end of the second MOS tube is coupled to the current-limiting node, and a second end of the second MOS tube is coupled to a first end of the second resistor.

Optionally, the second shunt control sub-unit includes: an inductor and a third MOS tube; a first end of the inductor is coupled to the control node, and a second end of the inductor is coupled to a control end of the third MOS tube; and a first end of the third MOS tube is coupled to the current-limiting node, and a second end of the third MOS tube is coupled to a first end of the second resistor.

Optionally, the drive control circuit further includes: a first voltage follower. A positive input end of the first voltage follower is coupled to the control node, and a negative input end and an output end of the first voltage follower are coupled to the control end of the first MOS tube.

Optionally, the first shunt control sub-unit further includes: a second voltage follower; and a positive input end of the second voltage follower is coupled to the control node, and a negative input end and an output end of the second voltage follower are coupled to the control end of the second MOS tube.

Optionally, the second shunt control sub-unit further includes: a third voltage follower; and a positive input end of the third voltage follower is coupled to the control node, and a negative input end and an output end of the third voltage follower are coupled to the control end of the third MOS tube.

Optionally, the drive control circuit further includes: a driver chip; and the voltage conversion sub-circuit, the first shunt sub-circuit, the conduction control sub-circuit and the second shunt sub-circuit are disposed inside the driver chip.

Optionally, the drive control circuit further includes: a driver chip. The voltage conversion sub-circuit, the first shunt sub-circuit, the conduction control sub-circuit and the second shunt sub-circuit are disposed outside of the driver chip; and the voltage conversion sub-circuit is coupled to a power pin of the driver chip.

Optionally, the current generated by the conduction control sub-circuit does not exceed a current threshold; and the current threshold is a ratio of a threshold voltage of the first transistor to a resistance value of the current-limiting resistor.

In a second aspect, embodiments of the present application further provide a drive system, including: a first voltage conversion module, a second voltage conversion module, a drive interface module and the above drive control circuit. The first voltage conversion module is configured to convert a power voltage into the supply voltage in response to a power-on enable trigger, and provide the supply voltage to the drive control circuit; and the second voltage conversion module is configured to receive an external supply voltage in response to a power-on enable trigger, and provide the external supply voltage to a Mini light-emitting diode (LED) backlight board via the drive interface module.

Optionally, the drive system further includes: a logic opening control module; and the logic opening control module is configured to send a start signal to a driver chip in response to the power-on enable trigger, to enable a logic control function of the driver chip.

In a third aspect, embodiments of the present application further provide a display apparatus, including: the drive system and the Mini LED backlight board described above; and the drive system is coupled to the Mini LED backlight board, and is configured to provide a drive signal to the Mini LED backlight board via the drive interface module.

In a fourth aspect, embodiments of the present application further provide a drive control method, including: outputting, by a voltage conversion sub-circuit, a supply voltage to a supply terminal; generating, by a first shunt sub-circuit, a first voltage at a current-limiting node based on the supply voltage at the supply terminal; generating, by a conduction control sub-circuit, a control voltage at a control node and generating a current flowing through the supply terminal to a ground terminal in response to the first voltage at the current-limiting node and the supply voltage at the supply terminal; and establishing a conducting path between the current-limiting node and the ground terminal by a second shunt sub-circuit, in response to the control voltage at the control node being greater than a first conduction threshold, for shunting the current generated by the conduction control sub-circuit.

Optionally, when the first shunt sub-circuit is turned on, and the second shunt sub-circuit is turned off, the current generated by the conduction control sub-circuit is a ratio of a voltage at the control node to a resistance value of a current-limiting resistor.

Optionally, when the first shunt sub-circuit is turned on, and the second shunt sub-circuit is turned on, the current generated by the conduction control sub-circuit is a ratio of a threshold voltage of a first transistor to a resistance value of a current-limiting resistor.

The beneficial effects of the present application are as follows.

In summary, embodiments of the present application provide a drive control circuit, a drive system and a display apparatus. The drive control circuit includes: a voltage conversion sub-circuit, a first shunt sub-circuit, a conduction control sub-circuit, and a second shunt sub-circuit. The voltage conversion sub-circuit is configured to output a supply voltage to the supply terminal; the first shunt sub-circuit is coupled with the supply terminal and the current-limiting node, and is configured to generate a first voltage at the current-limiting node based on the supply voltage at the supply terminal; the conduction control sub-circuit is coupled to the supply terminal, the current-limiting node and a ground terminal, and is configured to generate a control voltage at a control node and generate a current flowing through the supply terminal to the ground terminal in response to the first voltage at the current-limiting node and the supply voltage at the supply terminal; and the second shunt sub-circuit is coupled to a control node, the current-limiting node and the ground terminal, and is configured to establish a conducting path between the current-limiting node and the ground terminal in response to a voltage at the control node being greater than a first conduction threshold, for shunting the current generated by the conduction control sub-circuit. The setting of the above-described first shunt sub-circuit and second shunt sub-circuit achieves a purpose of limiting a current at the supply terminal, thereby effectively reducing the current that flows through the supply terminal, and improving the reliability of the supply voltage.

Other features and advantages of the present application will be set forth in the subsequent description, and partly become apparent from the description or will be understood by implementation of the present application. The objectives and other advantages of the present application may be realized and obtained by the structures as particularly indicated in the description, claims, and accompanying drawings.

### BRIEF DESCRIPTION OF FIGURES

The accompanying drawings illustrated herein are used for providing a further understanding of the present application and form a part of the present application. The schematic embodiments of the present application and their illustrations are used for explaining the present application and do not constitute an undue limitation of the present application.

FIG. 1 shows a schematic diagram of a drive system in the related art.

FIG. 2 shows a schematic diagram of a drive control circuit in the related art.

FIG. 3 shows a schematic diagram of a waveform of a supply voltage in a power-on process in the related art.

FIG. 4 shows a first schematic diagram of connection of a drive control circuit according to embodiments of the present application.

FIG. 5 shows a first schematic diagram of circuit connection of a drive control circuit according to embodiments of the present application.

FIG. 6 shows a first schematic diagram of a drive control circuit loaded with a power voltage according to embodiments of the present application.

FIG. 7 shows a second schematic diagram of circuit connection of a drive control circuit according to embodiments of the present application.

FIG. 8 shows a third schematic diagram of circuit connection of a drive control circuit according to embodiments of the present application.

FIG. 9 shows a schematic diagram of circuit connection of a drive system according to embodiments of the present application.

FIG. 10 shows another schematic diagram of circuit connection of a drive system in the related art.

FIG. 11 shows a first simulation waveform diagram of a drive control circuit according to embodiments of the present application.

FIG. 12 shows a second simulation waveform diagram of a drive control circuit according to embodiments of the present application.

FIG. 13 shows a third simulation waveform diagram of a drive control circuit in the related art.

FIG. 14 shows a fourth simulation waveform diagram of a drive control circuit according to embodiments of the present application.

FIG. 15 shows a fifth simulation waveform diagram of a drive control circuit according to embodiments of the present application.

FIG. 16 shows a sixth simulation waveform diagram of a drive control circuit in the related art.

FIG. 17 shows a flowchart of a drive control method according to embodiments of the present application.

### DETAILED DESCRIPTION

In order to make objectives, technical solutions and advantages of embodiments of the present application clearer, technical solutions of the present application will be described clearly and completely in the following in combination with accompanying drawings in embodiments of the present application. Obviously, the described embodiments are part of the embodiments of the technical solutions of the present application, and not all of the embodiments. Based on the embodiments in the present application, all other embodiments obtained by a person of ordinary skill in the art without creative labor fall within the scope of protection of technical solutions of the present application.

The terms “first”, “second”, etc., in the description and claims of the present disclosure as well as the above accompanying drawings are used to distinguish similar objects, and need not be used to describe a particular order or sequence. It should be understood that the data so used may be interchanged, where appropriate, so that the embodiments of the present disclosure described herein can be implemented using an order other than those illustrated or described herein.

In the related art, in a process that the Mini light-emitting diode (LED) related display apparatus is powered on, there may be a situation in which a high current is triggered by mistake or a situation in which the power filter capacitor inside the chip and other devices inside the chip generate parasitic oscillations on the power, etc. Both of the above situations may result in the generation of a high current, such as a surge. Generally, the capacitor inside the chip for controlling the Mini LED-related display apparatus can absorb a high current of up to 120 mA. When the above high current is higher, the load resistor inside the chip for processing the logic function may be damaged, and in serious cases, the Mini LED-related display apparatus may display poorly.

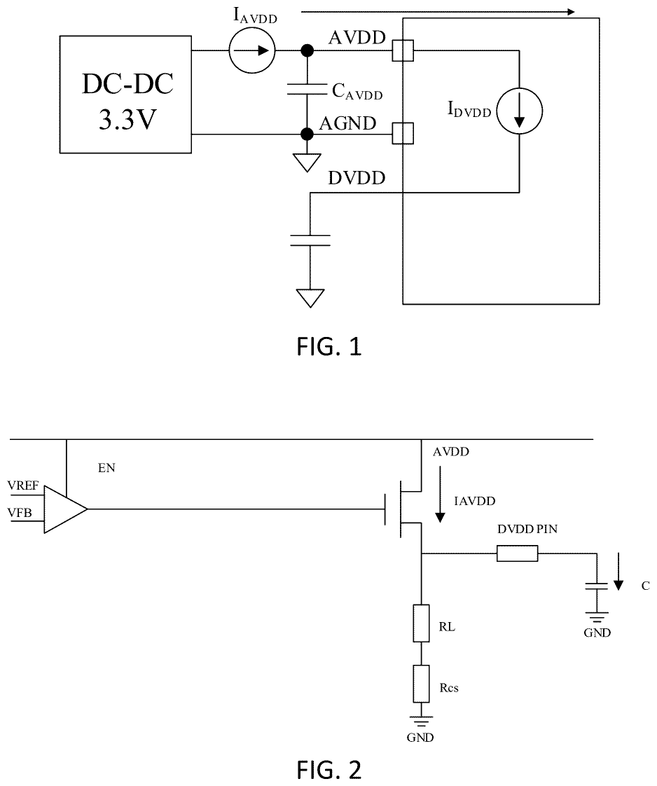

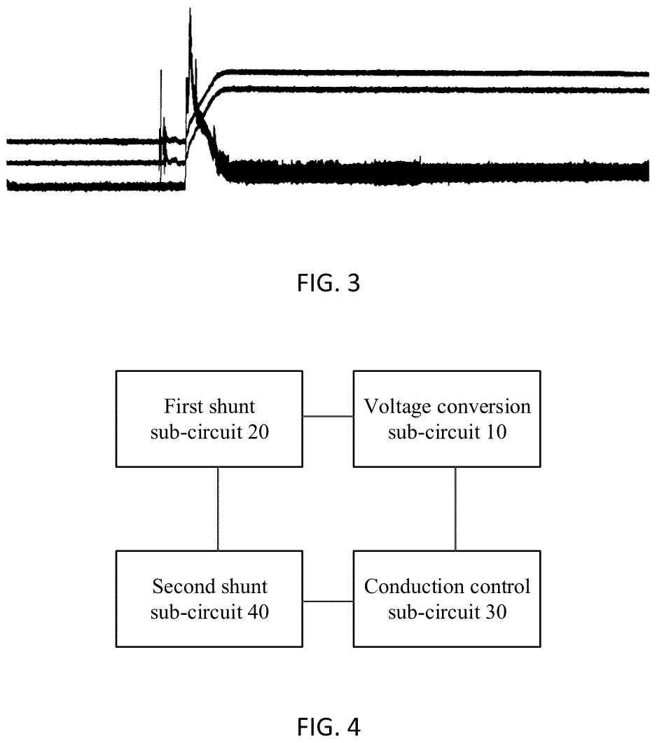

Referring to FIG. 1, FIG. 2 and FIG. 3, it is illustrated by the situation in which the power filter capacitor inside the chip and other devices inside the chip generate parasitic oscillations on the power, etc. When the power-on enable signal EN rises to about 80%, i.e., when the power voltage AVDD is about equal to the supply voltage DVDD, an internal circuit of the chip starts to operate. Taking the example that the capacitor inside the chip can absorb a high current of up to 120 mA for illustration, in FIG. 3, the high current overshoot (140 mA−120 mA) will cause a current of about 20 mA to enter into the load branch (i.e., the branch composed of RL and Rcs). In addition, the same Mini LED display apparatus may generate different values of high currents with the change of power-on time and power-on speed, and when it exceeds the maximum absorbable value of the capacitor inside the chip, there is a risk of the abnormal logic function and burning of certain devices in the chip.

The preferred embodiments of the present application are described in detail below in connection with the accompanying drawings.

Referring to FIG. 4, a drive control circuit provided in embodiments of the present application includes: a voltage conversion sub-circuit 10, a first shunt sub-circuit 20, a conduction control sub-circuit 30, and a second shunt sub-circuit 40.

In the implementation process, the above-described voltage conversion sub-circuit 10 is configured to convert a power voltage AVDD into a supply voltage DVDD, and output the supply voltage DVDD to a supply terminal Va.

Typically, the above-described voltage conversion sub-circuit 10 includes a switching tube. In a process that the Mini LED-related display apparatus is powered up, i.e., in response to a power-on enable trigger EN, the above-described switching tube is conducted, receives the supply voltage DVDD, and then provides the supply voltage DVDD to the supply terminal Va. It should be added that the degree of conduction of the above switching tube relates to the action rate of the power-on enable trigger EN. When the power voltage AVDD provided by the power-on enable trigger EN is gradually increasing and exceeds the threshold voltage for conduction of the above switching tube, the above switching tube is conducted.

The above-described first shunt sub-circuit 20 is coupled to the supply terminal Va and a current-limiting node Vb, and is configured to cause the current-limiting node Vb to generate a first voltage based on the supply voltage DVDD of the supply terminal Va.

In the implementation process, when the supply voltage DVDD in the supply terminal Va gradually increases in the power-on process, the above-described first shunt sub-circuit 20 causes the current-limiting node Vb to generate the first voltage based on the supply voltage DVDD of the supply terminal Va.

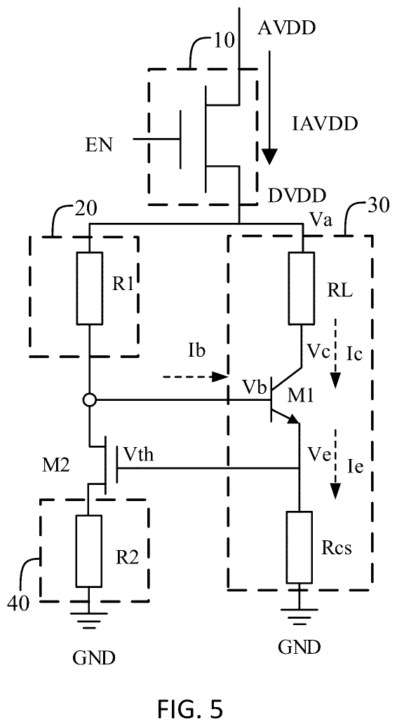

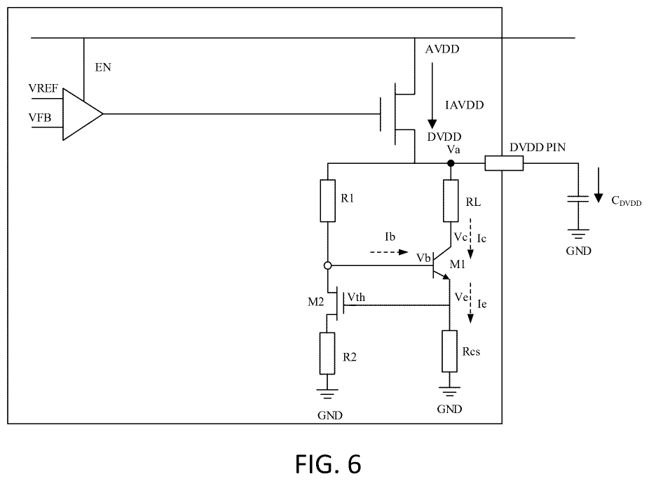

Referring to FIG. 5 and FIG. 6, the above first shunt sub-circuit 20 includes: a first resistor R1.

A first end of the first resistor R1 is coupled to the supply terminal Va, and a second end of the first resistor R1 is coupled to the current-limiting node Vb.

The above first resistor R1 is a new branch (assumed to be branch 1) sharing the supply voltage DVDD of the supply terminal Va, and a first voltage is generated at the current-limiting node Vb of this branch.

In order to ensure normal operation of the above first transistor M1, a resistance value of the first resistor R1 is less than a resistance value of a load resistor RL, and the resistance value of the first resistor R1 is less than a resistance value of the current-limiting resistor Rcs.

The resistance value of the above first resistor R1 is small, and usually the resistance value of the first resistor R1 is smaller than the resistance values of the load resistor RL and the current-limiting resistor Rcs in the conduction control sub-circuit 30. Therefore, when the first resistor R1 is connected to the circuit, because the resistance value of the first resistor R1 is small, the first voltage generated by the current-limiting node Vb is about equal to the supply voltage DVDD of the supply terminal Va, and the first transistor M1 is in a saturated state.

The above conduction control sub-circuit 30 is coupled to the supply terminal Va, the current-limiting node Vb and the ground terminal, and is configured to cause the control node Ve to generate a control voltage and generate a current flowing through the supply terminal Va to the ground terminal in response to the first voltage at the current-limiting node Vb and the supply voltage DVDD at the supply terminal Va.

In the implementation process, the above conduction control sub-circuit 30 is another branch (assumed to be branch 2) sharing the supply voltage DVDD of the supply terminal Va.

When the first voltage at the current-limiting node Vb is greater than the supply voltage DVDD at the supply terminal Va, the above conduction control sub-circuit 30 is conducted, and a control voltage is accordingly generated at the control node Ve. The above control voltage further causes the conduction control sub-circuit 30 to generate a current flowing through the supply terminal Va to the ground terminal.

Referring to FIG. 6, the above conduction control sub-circuit 30 includes: a load resistor RL, a first transistor M1, and a current-limiting resistor Rcs.

In FIG. 6, a first end of the load resistor RL is coupled to the supply terminal Va, and a second end of the load resistor RL is coupled to a first end of the first transistor M1.

A control end of the first transistor M1 is coupled to the current-limiting node Vb, and a second end of the first transistor M1 is coupled to the control node Ve.

A first end of the current-limiting resistor Rcs is coupled to the control node Ve, and a second end of the current-limiting resistor Rcs is coupled to a ground terminal.

In the implementation process, when the voltage at the current-limiting node Vb is greater than a threshold voltage of the first transistor M1, the first transistor M1 is conducted, and thus the supply voltage DVDD at the supply terminal Va causes a corresponding current to be generated on the load resistor RL and the current-limiting resistor Rcs.

It should be noted that when the conduction control sub-circuit 30 is in the on state, the above first transistor M1 is in the saturated state, and the current generated on the above load resistor RL is equal to the current generated on the above current-limiting resistor Rcs.

The above-described second shunt sub-circuit 40 is coupled to the control node Ve, the current-limiting node Vb and the ground terminal, and is configured to establish a conducting path between the current-limiting node Vb and the ground terminal in response to a voltage at the control node Ve being greater than the first conduction threshold, for shunting the current generated by the conduction control sub-circuit 30.

In the implementation process, the second shunt sub-circuit 40 described above is a third branch (assumed to be branch 3) sharing the supply voltage DVDD of the supply terminal Va. The second shunt sub-circuit 40 is coupled to the first shunt sub-circuit 20 and the conduction control sub-circuit 30, etc., via the control node Ve and the current-limiting node Vb, etc. When the voltage at the control node Ve is greater than the first conduction threshold, the branch circuit including the above-mentioned second shunt sub-circuit 40 is conducted, i.e., a conducting path between the current-limiting node Vb and the ground terminal is established via the second shunt sub-circuit 40, which can shunt the current generated by the conduction control sub-circuit 30.

Referring to FIG. 6, the above-described second shunt sub-circuit 40 includes: a shunt control unit and a second resistor R2.

In FIG. 6, the shunt control unit is configured to establish a conducting path between the current-limiting node Vb and the second resistor R2 in response to a current value at the control node Ve being greater than the first conduction threshold, for shunting the current generated by the conduction control sub-circuit 30.

The second resistor R2 described above is configured to conduct a shunt current, obtained by shunting the current generated by the conduction control sub-circuit 30, to ground.

In the implementation process, when the value of the current at the control node Ve is greater than the first conduction threshold, a conducting path between the shunt node and the second resistor R2 is established via the shunt control unit, and the shunt current after shunting the current generated by the conduction control sub-circuit 30 is then conducted to ground by the second resistor R2. Therefore, the magnitude of the current generated by the conduction control sub-circuit 30 is further limited, which further reduces the risk of the load resistor RL and the current-limiting resistor Rcs being burned.

The shunt control unit is described in the following according to different cases.

A first case: the above-described shunt control unit includes a first Metal-Oxide-Semiconductor (MOS) tube M2.

A control end of the first MOS tube M2 is coupled to a control node Ve, a first end of the first MOS tube M2 is coupled to a current-limiting node Vb, and a second end of the first MOS tube M2 is coupled to a first end of a second resistor R2.

In the implementation process, when the voltage at the control node Ve is greater than the first conduction threshold of the first MOS tube M2, the first MOS tube M2 is conducted, and the current-limiting node Vb is coupled to the second resistor R2 via the first MOS tube M2. In this case, the second shunt sub-circuit 40 specifically includes the first MOS tube M2 and the second resistor R2, and the first MOS tube M2 controls whether the second shunt sub-circuit 40 is turned on or turned off. When the first MOS tube M2 is conducted, the second shunt sub-circuit 40 shunts the current in the conduction control sub-circuit 30. When the first MOS tube M2 is cut off, the second shunt sub-circuit 40 does not shunt the current in the conduction control sub-circuit 30.

It is to be added that the current generated by the above-described conduction control sub-circuit does not exceed a current threshold. The current threshold is a ratio of a threshold voltage Vth of the first transistor M1 to a current-limiting resistor Rcs.

In the implementation process, when the second shunt sub-circuit 40 does not shunt the current in the conduction control sub-circuit 30, i.e., when the second shunt sub-circuit 40 is not conducted, the first transistor M1 is in a saturated state, and in this case, the current flowing through the load resistor is equal to the current flowing through the current-limiting resistor, i.e., the value of the current in the conduction control sub-circuit is the voltage at the control node Ve divided by the resistance of the current-limiting resistor; where the voltage of the above-described control node Ve is less than the threshold voltage Vth of the first transistor M1. When the second shunt sub-circuit 40 shunts the current in the conduction control sub-circuit 30, i.e., after the second shunt sub-circuit 40 is conducted, the first transistor M1 is in a critical saturation state, and the value of the current of the conduction control sub-circuit is a ratio of the threshold voltage Vth of the first transistor M1 to the current-limiting resistor Rcs.

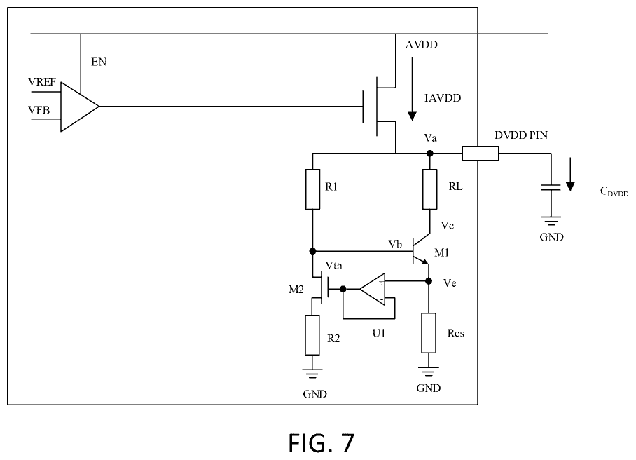

Furthermore, referring to FIG. 7, in order to restrict the current generated by the above-described shunt control unit from flowing inversely into the conduction control sub-circuit 30, the above-described drive control circuit further includes: a first voltage follower U1.

A positive input end of the first voltage follower U1 is coupled to the control node Ve, and a negative input end and an output end of the first voltage follower U1 are coupled to the control end of the first MOS tube M2.

The setting of the above-described first voltage follower U1 limits the current to flow only from the conduction control sub-circuit 30 to the above shunt control unit, and not from the shunt control unit to the conduction control sub-circuit 30. It is to be noted that the above-described current is usually a reverse current of a parasitic capacitor C of the first MOS tube M2, and the reverse current of the parasitic capacitor C may affect the voltage at the control node Ve, further generating current or voltage noise oscillation.

Considering that the high current and the like excited by the power-on false trigger or the power-on current are usually the alternating current, the second shunt sub-circuit 40 is further divided according to the case of shunting the alternating current component and the direct current component in the implementation process. That is, the shunt control unit described above includes: a first shunt control sub-unit and a second shunt control sub-unit.

A second case: the first shunt control sub-unit is configured to establish a conducting path between the current-limiting node Vb and the second resistor R2 in response to the voltage of the alternating current component at the control node Ve being greater than a first conduction threshold, for shunting the current generated by the conduction control sub-circuit 30.

In the implementation process, when the voltage of the alternating current component at the control node Ve is greater than the first conduction threshold, the first shunt control sub-unit is conducted, and a conducting path between the current-limiting node Vb and the second resistor R2 is established via the first shunt control sub-unit, for shunting the current generated by the conduction control sub-circuit 30.

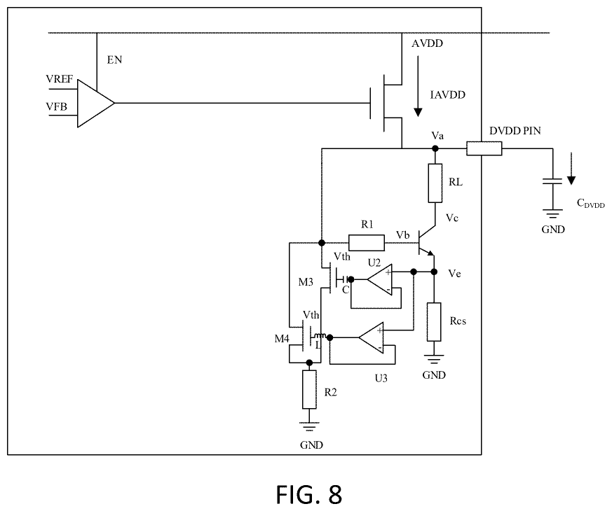

Referring to FIG. 8, the above-described first shunt control sub-unit includes: a capacitor Cand a second MOS tube M3.

A first end of the capacitor C is coupled to the control node Ve, and a second end of the capacitor C is coupled to a control end of the second MOS tube M3.

A first end of the second MOS tube M3 is coupled to the current-limiting node Vb, and a second end of the second MOS tube M3 is coupled to a first end of the second resistor R2.

In the implementation process, by utilizing the characteristic of the capacitor C to isolate the direct current and allow the alternating current to pass through, after the alternating current component generated by the conduction control sub-circuit 30 at the control node Ve flows through the capacitor C, if the voltage of the alternating current component is greater than the first conduction threshold, the second MOS tube M3 is conducted, and the second MOS tube M3 further conducts the above alternating current component into the second resistor R2 and the ground terminal, to shunt the alternating current component generated by the conduction control sub-circuit 30.

Similarly, as shown in FIG. 8, in order to restrict the reverse flow of the current generated by the first shunt control sub-unit into the conduction control sub-circuit 30, the first shunt control sub-unit further includes: a second voltage follower U2.

A positive input end of the second voltage follower U2 is coupled to the control node Ve, and a negative input end and an output end of the second voltage follower U2 are coupled to a control end of the second MOS tube M3.

The setting of the second voltage follower U2 limits the current to flow only from the conduction control sub-circuit 30 to the first shunt control sub-unit, and not from the first shunt control sub-circuit to the conduction control sub-circuit 30. Similarly, the setting of the second voltage follower U2 herein is also to avoid the reverse current of the parasitic capacitance C of the second MOS tube M3, and thereby avoid the current or voltage noise oscillation of the control node Ve.

A third case: the second shunt control sub-unit is configured to establish a conducting path between the current-limiting node Vb and the second resistor R2 in response to the voltage of the direct current component at the control node Ve being greater than the first conduction threshold, for shunting the current generated by the conduction control sub-circuit 30.

In the implementation process, when the voltage of the direct current component at the control node Ve is greater than the first conduction threshold, the second shunt control sub-unit is conducted, and a conducting path between the current-limiting node Vb and the second resistor R2 is established via the second shunt control sub-unit, to shunt the current generated by the conduction control sub-circuit 30.

Referring to FIG. 8, the above second shunt control sub-unit includes: an inductor Land a third MOS tube M4.

A first end of the inductor L is coupled to the control node Ve, and a second end of the inductor L is coupled to a control end of the third MOS tube M4.

A first end of the third MOS tube M4 is coupled to the current-limiting node Vb, and a second end of the third MOS tube M4 is coupled to a first end of the second resistor R2.

In the implementation process, utilizing the characteristic of the inductor L to allow the direct current to pass through and isolate the alternating current, after the direct current component generated by the conduction control sub-circuit 30 at the control node Ve flows through the inductor L, if the voltage of the direct current component is greater than the first conduction threshold, the third MOS tube M4 is conducted, and the third MOS tube M4 further introduces the above direct current component into the second resistor R2 and the ground terminal, to shunt the direct current component generated by the conduction control sub-circuit 30.

Similarly, as shown in FIG. 8, in order to restrict the reverse flow of the current generated by the second shunt control sub-unit into the conduction control sub-circuit 30, the second shunt control sub-unit further includes: a third voltage follower U3.

A positive input end of the third voltage follower U3 is coupled to the control node Ve, and a negative input end and an output end of the third voltage follower U3 are coupled to a control end of the third MOS tube M4.

The setting of the third voltage follower U3 limits the current to flow only from the conduction control sub-circuit 30 to the second shunt control sub-unit, and not from the second shunt control sub-unit to the conduction control sub-circuit 30. Similarly, the setting of the third voltage follower U3 herein is also to avoid the reverse current of the parasitic capacitance C of the third MOS tube M4, and thereby avoid the current or voltage noise oscillation of the control node Ve.

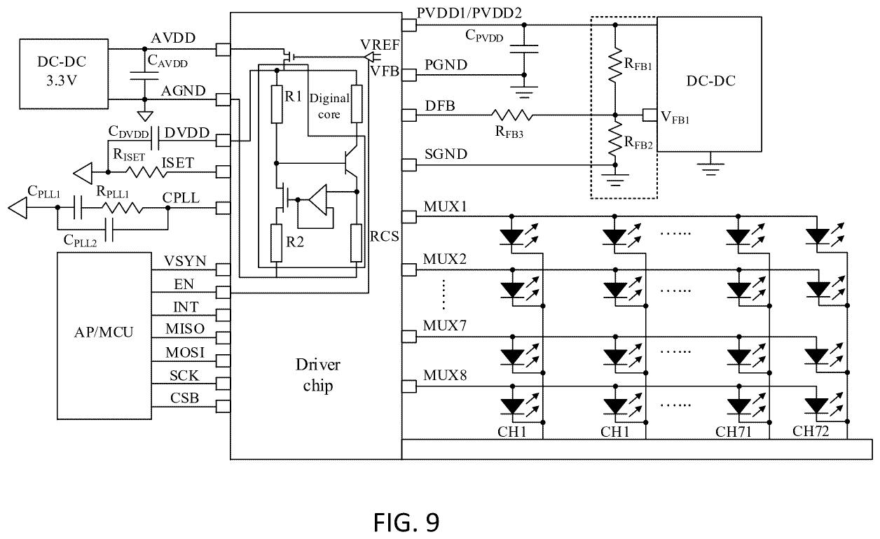

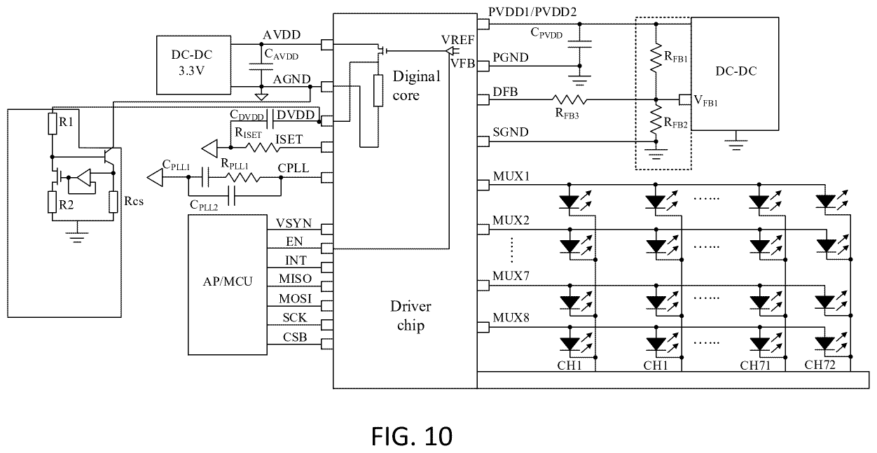

Furthermore, referring to FIG. 9 and FIG. 10, the drive control circuit further includes: a driver chip.

In one embodiment, referring to FIG. 9, the voltage conversion sub-circuit 10, the first shunt sub-circuit 20, the conduction control sub-circuit 30, and the second shunt sub-circuit 40 are disposed inside the driver chip.

Since the voltage conversion sub-circuit 10, the first shunt sub-circuit 20, the conduction control sub-circuit 30 and the second shunt sub-circuit 40 are all used for limiting the current generated by the chip-level supply voltage DVDD, the voltage conversion sub-circuit 10, the first shunt sub-circuit 20, the conduction control sub-circuit 30, and the second shunt sub-circuit 40 may all be provided inside the driver chip.

When the driver chip is powered on, i.e., when a gradually increasing power voltage AVDD is provided to the driver chip, the voltage conversion sub-circuit 10 converts the power voltage AVDD into the supply voltage DVDD, and the current generated by the supply voltage DVDD is then limited by the first shunt sub-circuit 20, the conduction control sub-circuit 30 and the second shunt sub-circuit 40.

In another embodiment, as shown in FIG. 10, the voltage conversion sub-circuit 10, the first shunt sub-circuit 20, the conduction control sub-circuit 30 and the second shunt sub-circuit 40 are disposed outside of the driver chip; and the voltage conversion sub-circuit 10 is coupled to the power pin of the chip.

Although, the voltage conversion sub-circuit 10, the first shunt sub-circuit 20, the conduction control sub-circuit 30 and the second shunt sub-circuit 40 are all used for limiting the current generated by the chip-level supply voltage DVDD, the voltage conversion sub-circuit 10, the first shunt sub-circuit 20, the conduction control sub-circuit 30 and the second shunt sub-circuit 40 can all be arranged outside of the driver chip; and the voltage conversion sub-circuit 10 is coupled to a power pin of the chip. In some embodiments, the drive control circuit may also be arranged on a driver board.

When the driver chip is powered on, i.e., when the gradually increasing power voltage AVDD is provided to the driver chip, the voltage conversion sub-circuit 10 obtains the power voltage AVDD through the power pin of the driver chip, and further converts the power voltage AVDD to the supply voltage DVDD. Then the first shunt sub-circuit 20, the conduction control sub-circuit 30 and the second shunt sub-circuit 40 limit the current generated by the supply voltage DVDD. The current after limitation is provided to the driver chip to enable the driver chip to realize corresponding logic functions.

The following is a detailed description of the specific working process of the drive control circuit.

In an initial power-on phase: after the power-on enable trigger EN, the voltage conversion sub-circuit 10 converts the power voltage AVDD, which starts to increase from 0, into the supply voltage DVDD, and provides the above supply voltage DVDD to the supply terminal Va. In this phase, the current generated by the supply voltage DVDD is less than an absorption limit of the capacitor C, i.e., the above current is all absorbed by the capacitor C, which ensures that the voltage difference of the load resistor RL remains unchanged, and the load current is unchanged.

In a power-on overshoot phase: as the power-on process proceeds, the supply voltage DVDD provided to the supply terminal Va also increases, and the current generated by the supply voltage DVDD will be greater than the absorption limit of the capacitor C. After the capacitor C absorbs the current at the absorption limit, there will still be some unnecessary current flowing through the load resistor RL. In order to ensure the normal operation of the load resistor RL, the second shunt sub-circuit 40 will be turned on, to ensure that the voltage difference of the load resistor RL remains unchanged and the load current remains unchanged, which is further described in detail in the following process.

(1) In the case of the large-current false trigger during the power-on process, when the rise time of the power-on enable trigger EN is up to 80% and is not up to 100%, and the current generated by the supply voltage DVDD does not exceed the absorption limit of the capacitor C and the normal current that can be withstood by the load resistor RL, a high current is not generated on the load resistor RL. Because the resistance value of the first resistor R1 is small, the voltage at the current-limiting node Vb is large (approximately equal to the supply voltage DVDD at the supply terminal Va), the first transistor M1 enters into a saturated state, and in this case, Ic≈Ie=Ve/Rcs. The second shunt sub-circuit 40 is not turned on in this case. It should be added that after the first transistor M1 is saturated, the voltage difference of Vbe is extremely small, and Vb≈Ve.

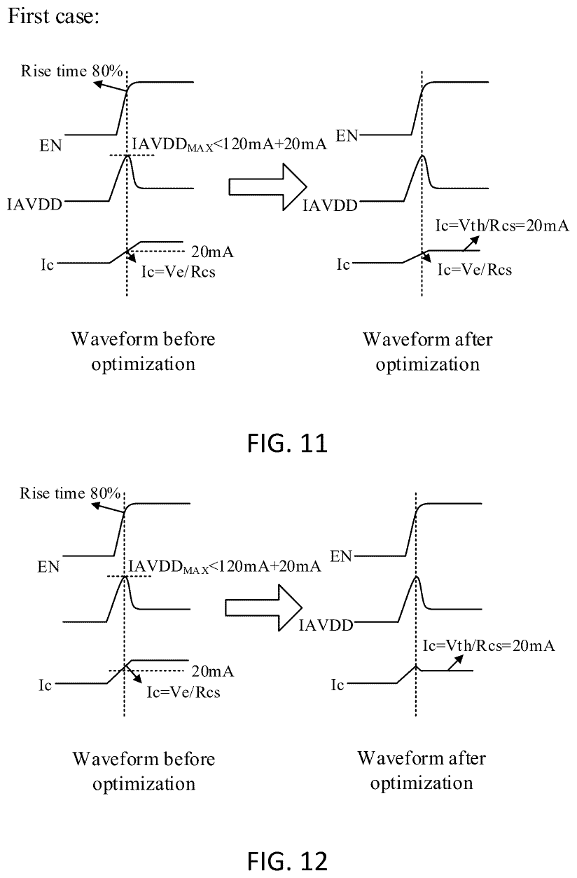

With the slow increase of the supply voltage DVDD at the supply terminal Va, if the control voltage at the control node Ve is greater than the first conduction threshold of the first MOS tube M2, the second shunt sub-circuit 40 is turned on, and in this case, the first MOS tube M2 is conducted and shunts the current on the load resistor RL, resulting in that the voltage of the current-limiting node Vb decreases, and the first transistor M1 enters an unsaturated state. Because the transistor in the unsaturated state has the current Ie=Ic+Ib, the drop of the current at the current-limiting node Vb may make the current of the current-limiting resistor Rcs drop, and then the voltage of the current-limiting resistor Rcs is reduced (Ve=Ie*Rcs). After continuous and repeated adjustments, until Ve≈Vth, the first transistor M1 is in a critical unsaturated state. In this case, the current on the current-limiting resistor Rcs≈the current on the load resistor RL=Ve/Rcs≈Vth/Rcs. The specific simulation waveforms are shown in FIG. 11 and FIG. 12.

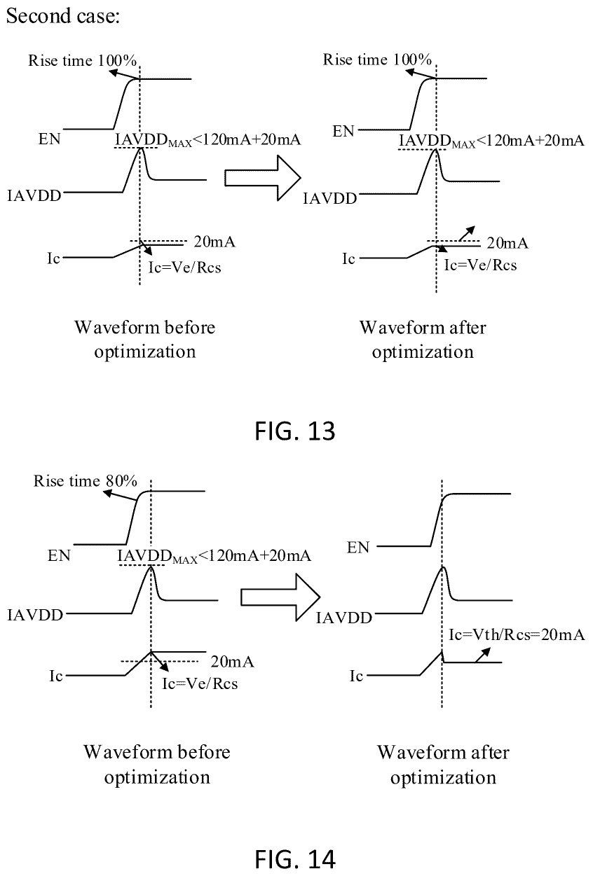

(2) In the case of the high current false trigger during the power-on process, when the rise time of the power-on enable trigger EN is up to 100%, and the current generated by the supply voltage DVDD does not exceed the absorption limit of the capacitor C and the normal current that can be withstood by the load resistor RL, there is no high current on the load resistor RL. If the voltage at the control node Ve is less than the threshold voltage of the first transistor M1, the first transistor M1 is in a saturated state, and the current on the current-limiting resistor Rcs≈the current on the load resistor RL≈Ve/Rcs. If the voltage at the control node Ve is greater than the first conduction threshold of the first MOS tube M2, the second shunt sub-circuit 40 is turned on, the first transistor M1 is in a critical saturation state, and the current on the current-limiting resistor Rcs≈the current on the load resistor RL=Ve/Rcs≈Vth/Rcs. Specific Simulation waveforms are shown in FIG. 13 and FIG. 14.

The above (1) and (2) effectively prevent the chip from being burnt due to the abnormal power voltage AVDD (e.g., the operator's error), etc.

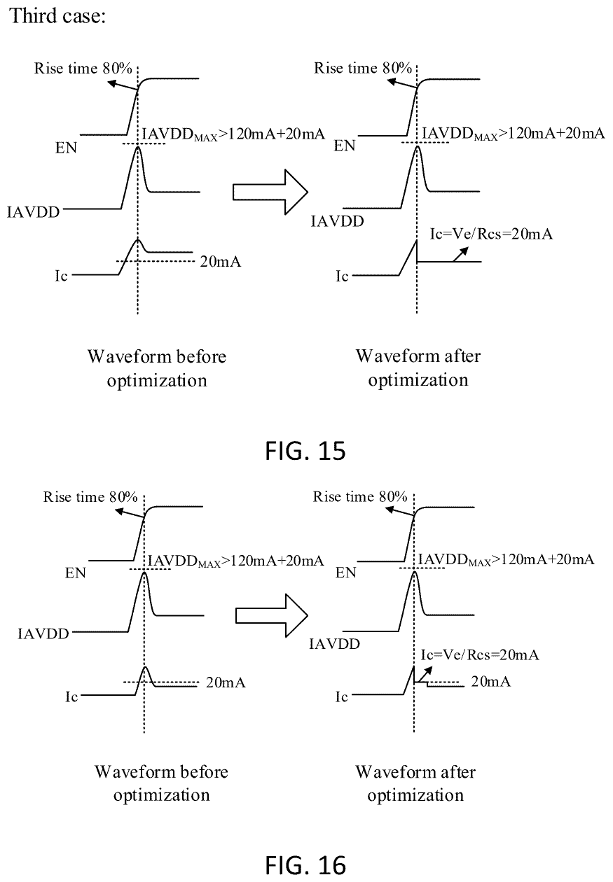

(3) In a case that the power filter capacitor C inside the chip and other devices inside the chip generate parasitic oscillations on the power, etc., when the rise time of the power-on enable trigger EN is up to 80%, and the current generated by the supply voltage DVDD exceeds the absorption limit of the capacitor C and the normal current that can be withstood by the load resistor RL, due to a sudden increase in the current of the load resistor RL, the voltage at the control node Ve is Ve=Ie*Rcs, and then the voltage at the control node Ve increases suddenly. When the voltage at the control node Ve is greater than the first conduction threshold of the first MOS tube M2, the second shunt sub-circuit 40 is turned on and the voltage at the control node Ve is reduced to Ve≈Vth. In this case, the first transistor M1 is in a critical saturation state, and the current on the current-limiting resistor Rcs≈the current on the load resistor RL=Ve/Rcs≈Vth/Rcs. The specific simulation waveforms are shown in FIG. 15 and FIG. 16.

The above (3) effectively avoids abnormality in the chip logic function that may be caused by the high current overshoot noise due to internal coupling or other factors.

Based on the same inventive concept, as shown in FIG. 9 and FIG. 10, embodiments of the present application provide a drive system including: a first voltage conversion module, a second voltage conversion module, a drive interface module, and the drive control circuit as described above.

In order to be able to cooperate with the Mini LED backlight board at the rear end, the drive system in the embodiments of the present application further includes a first voltage conversion module, a second voltage conversion module and a drive interface module for use in conjunction with the above-described drive control circuit.

The first voltage conversion module, in response to a power-on enable trigger EN, converts an externally input power voltage into a supply voltage, and further provides the supply voltage to the drive control circuit.

In the implementation process, when the power-on enable trigger EN is effective, the first voltage conversion module receives the power voltage AVDD, then converts the power voltage AVDD into the supply voltage DVDD, and further provides the supply voltage DVDD to the drive control circuit. It is to be noted that the common first voltage conversion module is used for direct-current voltage conversion, for example, a direct-current voltage 5V is converted to a direct-current voltage 3.3V.

In the implementation process, the second voltage conversion module is configured to receive the external supply voltage PVDD in response to a power-on enable trigger, and provide the external supply voltage PVDD to the Mini LED backlight board via the drive interface module. Typically, the second voltage conversion module is configured to boost the external supply voltage PVDD provided externally to increase the driving capability of the external supply voltage PVDD, and further provide the voltage to the Mini LED backlight board via the drive interface module, i.e., the external supply voltage PVDD is divided into multiple circuits via the drive interface module and then provided to the Mini LED backlight board. Usually, in order to ensure the stability of the power of the Mini LED backlight board, a feedback signal, such as DC-DC feedback (DFB), is also provided to feed back to adjust the external supply voltage PVDD.

In addition, the above-described drive system also includes a logic opening control module.

The logic opening control module is configured to send a start signal to the driver chip in response to a power-on enable trigger, to enable a logic control function of the driver chip.

In the implementation process, the above-described drive system further includes a logic opening control module, often referred to as an application processor (AP) terminal or microcontroller unit (MCU). The logic opening control module is configured to send a start signal, e.g., a serial peripheral interface (SPI) signal, etc., so as to control the driver chip to enable the logic control function.

Based on the same inventive concept, embodiments of the present application provide a display apparatus including: the drive system and the Mini LED backlight board as described above.

The drive system is coupled to the Mini LED backlight board, and is configured to provide a drive signal to the Mini LED backlight board via the drive interface module.

In the implementation process, the above-described drive system is electrically connected to the Mini LED backlight board via the drive interface module. When the current for driving is limited in the drive system, the above limited current is converted into a drive signal adapted to the Mini LED backlight board via the drive interface module, and the above drive signal is provided to the Mini LED backlight board.

The above display apparatus provided by the embodiments of the present application may be a tablet computer, a television, a monitor, a laptop computer, a digital photo frame, a navigator, or any other product or component having a display function. Other essential components of the display apparatus should be understood by those of ordinary skill in the art, and are not described herein, nor should they be used as a limitation of the present application.

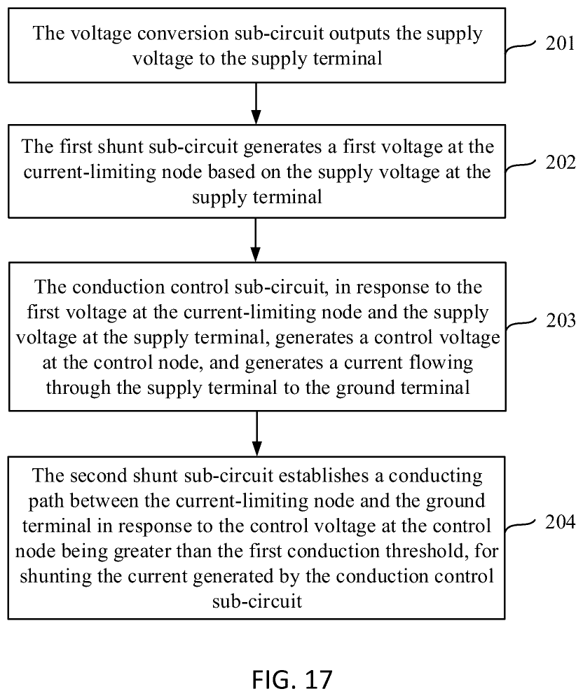

Based on the same inventive concept, embodiments of the present application provide a drive control method, with reference to FIG. 17, including the following.

Step 201: the voltage conversion sub-circuit 10 outputs the supply voltage DVDD to the supply terminal Va.

In the implementation process, under the action of the power-on enable trigger EN, the power voltage AVDD which increases from a small value is provided to the voltage conversion sub-circuit 10, and then the voltage conversion sub-circuit 10 converts the obtained power voltage AVDD into the supply voltage DVDD. Usually, the voltage conversion sub-circuit 10 is a switching transistor. Then the voltage conversion sub-circuit 10 outputs the supply voltage DVDD to the supply terminal Va, i.e., the voltage value DVDD at the node Va is equal to the value AVDD of the power voltage AVDD.

Step 202: the first shunt sub-circuit 20 generates a first voltage at the current-limiting node Vb based on the supply voltage DVDD at the supply terminal Va.

Under the action of the supply voltage DVDD at the supply terminal Va, the first shunt sub-circuit 20 causes the current-limiting node Vb to generate a first voltage based on the supply voltage DVDD, i.e., the voltage value at the node Vb is the first voltage.

Step 203: the conduction control sub-circuit 30, in response to the first voltage at the current-limiting node Vb and the supply voltage DVDD at the supply terminal Va, generates a control voltage at the control node Ve, and generates a current flowing through the supply terminal Va to the ground terminal.

In the implementation process, whether the conduction control sub-circuit 30 is turned on or turned off mainly depends on whether the first transistor M1 is turned on. When the first voltage of the above current-limiting node Vb is greater than the supply voltage DVDD of the supply terminal Va, i.e., when the first voltage of the current-limiting node Vb is greater than a threshold voltage of the first transistor M1, the first transistor M1 is conducted; and the conduction control sub-circuit 30 including the load resistor RL, the first transistor M1 and the current-limiting resistor Rcs generates a control voltage at the control node Ve, and generates the current flowing through the supply terminal Va to the ground terminal.

It should be noted that since the above first transistor M1 is in a saturated conduction state, the current of the above load resistor RL is equal to the current Ib of the current-limiting resistor Rcs.

That is, in the embodiments, when the first shunt sub-circuit is turned on, and the second shunt sub-circuit is turned off, the current generated by the conduction control sub-circuit is a ratio of the voltage at the control node Ve to the current-limiting resistor Rcs.

In the implementation process, when the circuit including the first resistor R1 connected to the supply terminal, and the circuit including the load resistor RL connected to the supply terminal, the first transistor M1 and the current-limiting resistor Rcs are conducted, i.e., when the above conduction control sub-circuit is shunted only through the first shunt sub-circuit, the first transistor M1 is in a saturated state, and the current generated by the conduction control sub-circuit is a ratio of the voltage at the control node Ve to the current-limiting resistor Rcs.

Step 204: the second shunt sub-circuit 40 establishes a conducting path between the current-limiting node Vb and the ground terminal in response to the control voltage at the control node Ve being greater than the first conduction threshold, for shunting the current generated by the conduction control sub-circuit 30.

In order to protect the above load resistor RL from being burned by the excessive current, when the current in the conduction control sub-circuit 30 is excessive, the current at the control node Ve will be greater than the first conduction threshold of the first MOS tube M2, the second MOS tube M3, or the third MOS tube M4 in the shunt control unit. In this case, the second shunt sub-circuit 40 is conducted, i.e., the shunt control unit and the second resistor form a new current-limiting branch circuit to shunt the current generated by the conduction control sub-circuit 30, thereby further reducing the current of the conduction control sub-circuit 30.

In another embodiment, when the first shunt sub-circuit is turned on, and the second shunt sub-circuit is turned on, the current generated by the conduction control sub-circuit is a ratio of a threshold voltage of the first transistor to a resistance value of the current-limiting resistor.

In the implementation process, when the circuit including the first resistor R1 connected to the supply terminal is turned on, the circuit including the load resistor RL connected to the supply terminal, the first transistor M1 and the current-limiting resistor Rcs is turned on, and the circuit including the second resistor R2 and the shunt control unit is also on, i.e., when the above conduction control sub-circuit is shunted through the first shunt sub-circuit and the second shunt sub-circuit at the same time, the first transistor M1 is in a critical saturation state, and the current generated by the conduction control sub-circuit is a ratio of the threshold voltage Vth of the first transistor M1 to a resistance value of the current-limiting resistor Rcs.

In summary, embodiments of the present application provide a drive control circuit, a drive system and a display apparatus. The drive control circuit includes: a voltage conversion sub-circuit, a first shunt sub-circuit, a conduction control sub-circuit, and a second shunt sub-circuit. The voltage conversion sub-circuit is configured to output a supply voltage to the supply terminal; the first shunt sub-circuit is coupled with the supply terminal and the current-limiting node, and is configured to generate a first voltage at the current-limiting node based on the supply voltage at the supply terminal; the conduction control sub-circuit is coupled to the supply terminal, the current-limiting node and a ground terminal, and is configured to generate a control voltage at a control node and generate a current flowing through the supply terminal to the ground terminal in response to the first voltage at the current-limiting node and the supply voltage at the supply terminal; and the second shunt sub-circuit is coupled to a control node, the current-limiting node and the ground terminal, and is configured to establish a conducting path between the current-limiting node and the ground terminal in response to a voltage at the control node being greater than a first conduction threshold, for shunting the current generated by the conduction control sub-circuit. The setting of the above-described first shunt sub-circuit and second shunt sub-circuit achieves a purpose of limiting a current at the supply terminal, thereby effectively reducing the current that flows through the supply terminal, and improving the reliability of the supply voltage.

It should be appreciated by those skilled in the art that embodiments of the present application may be provided as methods, systems, or computer program product systems. Therefore, the present application may take a form of a fully hardware embodiment, a fully software embodiment, or an embodiment that combines software and hardware aspects. Further, the present application may take a form of a computer program product system implemented on one or more computer-usable storage media (including, but not limited to, a disk memory, a compact disc read-only memory (CD-ROM), an optical memory, and the like) that contain computer-usable program codes therein.

The present application is described with reference to flowcharts and/or block diagrams of methods, devices (systems), and computer program product systems of the present application. It is to be understood that each process and/or box in the flowchart and/or block diagram, and the combination of processes and/or boxes in the flowchart and/or block diagram, may be implemented by computer program instructions. These computer program instructions may be provided to processor(s) of a general-purpose computer, a special-purpose computer, an embedded processor, or other programmable data processing device to produce a machine, such that the instructions executed by the processor of the computer or other programmable data processing device produce an apparatus for implementing the functions specified in one or more processes of the flowchart and/or one or more boxes in the block diagram.

These computer program instructions may also be stored in a computer-readable memory capable of directing the computer or other programmable data processing device to operate in a particular manner, such that the instructions stored in the computer-readable memory produce an article of manufacture including an instruction device that implements the function specified in one or more processes in the flowchart and/or one or more boxes in the block diagram.

These computer program instructions may also be loaded onto a computer or other programmable data processing device, such that a series of operational steps are performed on the computer or other programmable device to produce computer-implemented processing, such that the instructions executed on the computer or other programmable device provide steps for implementing the function specified in one or more processes in the flowchart and/or one or more boxes in the block diagram.

Obviously, those skilled in the art can make various changes and variations to the present application without departing from the spirit and scope of the present application. Thus, if such modifications and variations of the present application are within the scope of the claims of the present application and their technical equivalents, the present application is intended to encompass such modifications and variations.

1.-21. (canceled)

22. A drive control circuit, comprising: a voltage conversion sub-circuit, a first shunt sub-circuit, a conduction control sub-circuit, and a second shunt sub-circuit;
wherein the voltage conversion sub-circuit is configured to output a supply voltage to a supply terminal;
the first shunt sub-circuit is coupled to the supply terminal and a current-limiting node, and is configured to generate a first voltage at the current-limiting node based on the supply voltage at the supply terminal;
the conduction control sub-circuit is coupled to the supply terminal, the current-limiting node and a ground terminal, and is configured to generate a control voltage at a control node and generate a current flowing through the supply terminal to the ground terminal in response to the first voltage at the current-limiting node and the supply voltage at the supply terminal; and
the second shunt sub-circuit is coupled to the control node, the current-limiting node, and the ground terminal, and is configured to establish a conducting path between the current-limiting node and the ground terminal in response to the control voltage at the control node being greater than a first conduction threshold, for shunting the current generated by the conduction control sub-circuit.

23. The circuit according to claim 22, wherein the first shunt sub-circuit comprises: a first resistor; and
a first end of the first resistor is coupled to the supply terminal, and a second end of the first resistor is coupled to the current-limiting node.

24. The circuit according to claim 23, wherein the conduction control sub-circuit comprises: a load resistor, a first transistor, and a current-limiting resistor;
a first end of the load resistor is coupled to the supply terminal, and a second end of the load resistor is coupled to a first end of the first transistor;
a control end of the first transistor is coupled to the current-limiting node, and a second end of the first transistor is coupled to the control node; and
a first end of the current-limiting resistor is coupled to the control node, and a second end of the current-limiting resistor is coupled to the ground terminal;
wherein a resistance value of the first resistor is less than a resistance value of the load resistor, and the resistance value of the first resistor is less than a resistance value of the current-limiting resistor.

25. The circuit according to claim 22, wherein the second shunt sub-circuit comprises:
a shunt control unit and a second resistor;
the shunt control unit is configured to establish a conducting path between the current-limiting node and the second resistor in response to a current value at the control node being greater than the first conduction threshold, for shunting the current generated by the conduction control sub-circuit; and
the second resistor is configured to conduct a shunt current, obtained by shunting the current generated by the conduction control sub-circuit, to ground.

26. The circuit according to claim 25, wherein the shunt control unit comprises a first Metal-Oxide-Semiconductor (MOS) tube; and
a control end of the first MOS tube is coupled to the control node, a first end of the first MOS tube is coupled to the current-limiting node, and a second end of the first MOS tube is coupled to a first end of the second resistor.

27. The circuit according to claim 25, wherein the shunt control unit comprises: a first shunt control sub-unit and a second shunt control sub-unit;
the first shunt control sub-unit is configured to establish a conducting path between the current-limiting node and the second resistor in response to a voltage of an alternating current component at the control node being greater than the first conduction threshold, for shunting the current generated by the conduction control sub-circuit; and
the second shunt control sub-unit is configured to establish a conducting path between the current-limiting node and the second resistor in response to a voltage of a direct current component at the control node being greater than the first conduction threshold, for shunting the current generated by the conduction control sub-circuit.

28. The circuit according to claim 27, wherein the first shunt control sub-unit comprises: a capacitor and a second MOS tube;
a first end of the capacitor is coupled to the control node, and a second end of the capacitor is coupled to a control end of the second MOS tube; and
a first end of the second MOS tube is coupled to the current-limiting node, and a second end of the second MOS tube is coupled to a first end of the second resistor.

29. The circuit according to claim 27, wherein the second shunt control sub-unit comprises: an inductor and a third MOS tube;
a first end of the inductor is coupled to the control node, and a second end of the inductor is coupled to a control end of the third MOS tube; and
a first end of the third MOS tube is coupled to the current-limiting node, and a second end of the third MOS tube is coupled to a first end of the second resistor.

30. The circuit according to claim 26, further comprising: a first voltage follower;
wherein a positive input end of the first voltage follower is coupled to the control node, and a negative input end and an output end of the first voltage follower are coupled to the control end of the first MOS tube.

31. The circuit according to claim 28, wherein the first shunt control sub-unit further comprises: a second voltage follower;
wherein a positive input end of the second voltage follower is coupled to the control node, and a negative input end and an output end of the second voltage follower are coupled to the control end of the second MOS tube.

32. The circuit according to claim 29, wherein the second shunt control sub-unit further comprises: a third voltage follower;
wherein a positive input end of the third voltage follower is coupled to the control node, and a negative input end and an output end of the third voltage follower are coupled to the control end of the third MOS tube.

33. The circuit according to claim 22, further comprising: a driver chip;
wherein the voltage conversion sub-circuit, the first shunt sub-circuit, the conduction control sub-circuit and the second shunt sub-circuit are disposed inside the driver chip.

34. The circuit according to claim 22, further comprising: a driver chip;
wherein the voltage conversion sub-circuit, the first shunt sub-circuit, the conduction control sub-circuit and the second shunt sub-circuit are disposed outside of the driver chip; and
the voltage conversion sub-circuit is coupled to a power pin of the driver chip.

35. The circuit according to claim 24, wherein the current generated by the conduction control sub-circuit does not exceed a current threshold;
wherein the current threshold is a ratio of a threshold voltage of the first transistor to a resistance value of the current-limiting resistor.

36. A drive system, comprising: a first voltage conversion module, a second voltage conversion module, a drive interface module and the drive control circuit according to claim 22;
wherein the first voltage conversion module is configured to convert a power voltage into the supply voltage in response to a power-on enable trigger, and provide the supply voltage to the drive control circuit; and
the second voltage conversion module is configured to receive an external supply voltage in response to the power-on enable trigger, and provide the external supply voltage to a Mini light-emitting diode (LED) backlight board via the drive interface module.

37. The drive system according to claim 36, further comprising a logic opening control module;
wherein the logic opening control module is configured to send a start signal to a driver chip in response to the power-on enable trigger, to enable a logic control function of the driver chip.

38. A display apparatus, comprising: the drive system and the Mini LED backlight board according to claim 36;
wherein the drive system is coupled to the Mini LED backlight board, and is configured to provide a drive signal to the Mini LED backlight board via the drive interface module.

39. A drive control method, comprising:
outputting, by a voltage conversion sub-circuit, a supply voltage to a supply terminal;
generating, by a first shunt sub-circuit, a first voltage at a current-limiting node based on the supply voltage at the supply terminal;
generating, by a conduction control sub-circuit, a control voltage at a control node and generating a current flowing through the supply terminal to a ground terminal in response to the first voltage at the current-limiting node and the supply voltage at the supply terminal; and
establishing a conducting path between the current-limiting node and the ground terminal by a second shunt sub-circuit, in response to the control voltage at the control node being greater than a first conduction threshold, for shunting the current generated by the conduction control sub-circuit.

40. The method according to claim 39, wherein, when the first shunt sub-circuit is turned on, and the second shunt sub-circuit is turned off, the current generated by the conduction control sub-circuit is a ratio of a voltage at the control node to a resistance value of a current-limiting resistor.

41. The method according to claim 39, wherein, when the first shunt sub-circuit is turned on, and the second shunt sub-circuit is turned on, the current generated by the conduction control sub-circuit is a ratio of a threshold voltage of a first transistor to a resistance value of a current-limiting resistor.
